(19) United States
(12) Patent Application Publication
(10) Pub. No.: US 2014/0200957 A1
(43) Pub. Date: Jul. 17, 2014

(54) SYSTEM AND METHOD FOR DETERMINING CUSTOMER PREFERENCES

(71) Applicant: Iqua Technologies Pty Ltd, Hawthorn (AU)

(72) Inventor: Phillip Biggs, Hawthorn (AU)

(73) Assignee: Iqua Technologies Pty Ltd, Hawthorn (AU)

(21) Appl. No.: 14/153,186

(22) Filed: Jan. 13, 2014

Related U.S. Application Data
(60) Provisional application No. 61/753,027, filed on Jan. 16, 2013.

(51) Int. Cl. G06Q 30/02

(52) U.S. Cl. CPC G06Q 30/0201
USPC 705/7.29

(57) ABSTRACT

Exemplary embodiments provide a method for determining a customer preference, the method includes receiving, at a merchant terminal, a customer ID token from a customer identification device; the merchant terminal communicating the customer ID token to a preference storage server which includes a plurality of customer preference records that are associated with one of a plurality of different customer ID tokens. The preference storage server determines a refined set of customer preference records associated with the customer ID token, and communicates, to a merchant associated with the merchant terminal, the refined set of customer preference records.

### CROSS-REFERENCE TO RELATED APPLICATIONS

This application claims priority to U.S. Provisional Patent Application No. 61/753,027, filed on Jan. 16, 2013, the entire contents of which are incorporated herein by reference.

### FIELD OF THE INVENTION

The invention generally relates to improvements in provision of goods and services to customers, in particular through storage of individual customer preferences in a database.

### BACKGROUND TO THE INVENTION

It is common for customers to regularly order goods and/or services which are of the same type or configuration, whether from the same merchant or several merchants. For example, a customer may regularly order the same type of coffee from one café, but may also order the same coffee from other cafés. Presently, a merchant may rely upon familiarity with a customer in order to predict the goods and/or services that the customer is likely to want to order, however this suffers from several problems.

At peak times, there may be insufficient human resources to efficiently identify regular customers and to provide the regular customers with their preferred goods and/or services. Furthermore, if a customer visits a merchant who does not have a requisite familiarity, the merchant is unlikely to accurately predict the goods and/or services desired by the customer.

In the field of retail customer service, quick and accurate determination of customer preferences (such as preferred types of goods and/or services) is important. Quick recognition of customer preferences may lead to more efficient retail sales processes, generation of more transactions within a specified period, and as a result may lead to greater customer satisfaction. Furthermore, accurate recognition of customer preferences may reduce waste. It would therefore be desirable to provide a system and/or method for providing accurate determination of customer preferences.

### SUMMARY OF THE INVENTION

According to an embodiment of the present invention, there is provided a method for determining a customer preference, the method including the steps of: receiving, at a merchant terminal, a customer ID token from a customer identification device; the merchant terminal communicating the customer ID token to a preference storage server, the preference storage server including a plurality of customer preference records, each associated with one of a plurality of different customer ID tokens; the preference storage server determining a refined set of customer preference records associated with the customer ID token; and the preference storage server communicating to a merchant associated with the merchant terminal the refined set of customer preference records.

Optionally, the method further includes the step of: the preference storage server determining the refined set of customer preference records based on a set of customer preference records and one or more further parameters.

Optionally, the one or more of the customer preference records are associated with one of a plurality of different merchants. Each of the customer preference records may be associated with one of a plurality of different merchants. A further parameter may correspond to the merchant associated with the merchant terminal. Another further parameter may correspond to the time of day at which the customer ID token is received at the merchant terminal. Another further parameter may be a merchant type associated with the merchant terminal.

Optionally, the customer identification device is a Near Field Communication (NFC) device. The NFC device may correspond to a NFC tag. Alternatively, the NFC device may correspond to a mobile phone. Furthermore, the merchant terminal may include a NFC reader, and the method further includes the step of the NFC reader reading information stored on or with the NFC device, the information including the customer ID token. Alternatively, the customer identification device may be a biometric indicator.

Optionally, the merchant terminal is configured to communicate with the preference storage server over a network. The network may be the Internet.

In an embodiment, the refined set of preference records corresponds to a purchase to be made by the customer from the merchant, and the method includes the steps of: the merchant terminal receiving a purchase ID token from the customer identification device, and communicating the purchase ID token to a purchase payment server; the purchase payment server determining a customer purchase record associated with the purchase ID token; the purchase payment server determining that the purchase can be paid for based on the customer purchase record; and the purchase payment server communicating to the merchant terminal that the purchase has been paid for. The purchase ID token may be the same information as the customer ID token. The customer purchase record may be a credit record. Alternatively, the customer purchase record may be a payment record. The purchase payment server may be a component of the preference storage server.

Optionally, the method includes the step of the merchant terminal communicating the refined set of customer preference records to the purchase payment server. Alternatively, the method may include the step of the preference storage server communicating the refined set of customer preference records to the purchase payment server.

In an embodiment, the method includes the step of a purchase history storage server, including purchase data associated with the customer ID token, providing purchase data to the merchant terminal. Alternatively, in an embodiment the method includes the step of a purchase history storage server, including purchase data associated with the customer ID token, providing the purchase data to the purchase storage server. The method may include the further step of the purchase storage server providing a discount to a purchase made by the customer based on the purchase data provided by the purchase history storage server. The method may further include the step of storing within the purchase history storage server purchase data associated with the purchase.

According to another embodiment of the present invention, there is provided a system for determining customer preferences, including: a preference storage server including a database; and one or more merchant terminals in communication with the customer preference storage server, wherein the database includes a plurality of customer preference records, each associated with one of a plurality of different customer ID tokens, and wherein the preference storage server is configured for: receiving a customer ID token from a merchant terminal, determining a refined set of customer preference records associated with the customer ID token; and communicating to a merchant associated with the merchant terminal the refined set of customer preference records.

Optionally, the preference storage server is further configured for determining a set of customer preference records based on the customer ID token and one or more further parameters, and wherein the refined set of customer preference records is based on the set of customer preference records and the one or more further parameters.

One or more of the customer preference records may be associated with one of a plurality of different merchants. Each of the customer preference records may be associated with one of a plurality of different merchants.

A further parameter may correspond to the merchant associated with the merchant terminal. Another further parameter may correspond to the time of day at which the customer ID token is received at the merchant terminal. Another further parameter may be a merchant type associated with the merchant terminal.

The customer identification device may be an NFC device. The NFC device may correspond to an NFC tag. Alternatively, the NFC device may correspond to a mobile phone. Alternatively, the customer identification device may be a biometric indicator.

The merchant terminal may include an NFC reader configured for reading information stored on or with the NFC device, the information including the customer ID token.

The merchant terminal may be configured for communication with the preference storage server over a network. The network may be the Internet.

In an embodiment, the refined set of preference records corresponds to a purchase, and the merchant terminal is configured for receiving a purchase ID token from the customer identification device, and the system includes a purchase payment server, the purchase payment server configured for: receiving the purchase ID token from the merchant terminal; determining a customer purchase record associated with the purchase ID token; determining that the purchase can be paid for based on the customer purchase record; and communicating to the merchant terminal that the purchase has been paid for. The purchase ID token may be the same information as the customer ID token. The customer purchase record may be a customer credit record. The customer purchase record may alternatively be a customer payment record.

Optionally, the purchase payment server is a component of the preference storage server.

Optionally, the merchant terminal is configured for communicating the refined set of customer preference records to the purchase payment server. Alternatively, the preference storage server is optionally configured for communicating the refined set of customer preference records to the purchase payment server.

In an embodiment, the merchant terminal is configured for receiving purchase data associated with the customer ID token from a purchase history storage server. Alternatively, the purchase storage server may be configured for receiving purchase data associated with the customer ID token from a purchase history purchase data associated with the customer ID token from a purchase history storage server. The purchase storage server may be configured for providing a discount to a purchase made by the customer based on the purchase data provided by the purchase history storage server. The purchase history storage server may be configured for storing purchase data associated with the purchase.

### BRIEF DESCRIPTION OF THE DRAWINGS

Embodiments of the invention will now be described with reference to the accompanying drawings. It is to be appreciated that the embodiments are given by way of illustration only and the invention is not limited by this illustration. In the drawings:

FIG. 1 shows a customer preference system;

FIG. 2 shows a schematic view of a preference storage server;

FIG. 3 shows a merchant terminal and a customer identification device;

FIG. 4 shows a customer preference system including a purchase payment server;

FIG. 5 shows a customer preference system including a purchase history storage server; and

FIG. 6 shows a customer preference system including combined preference storage server, purchase storage server, and purchase history storage server.

### DESCRIPTION OF PREFERRED EMBODIMENT

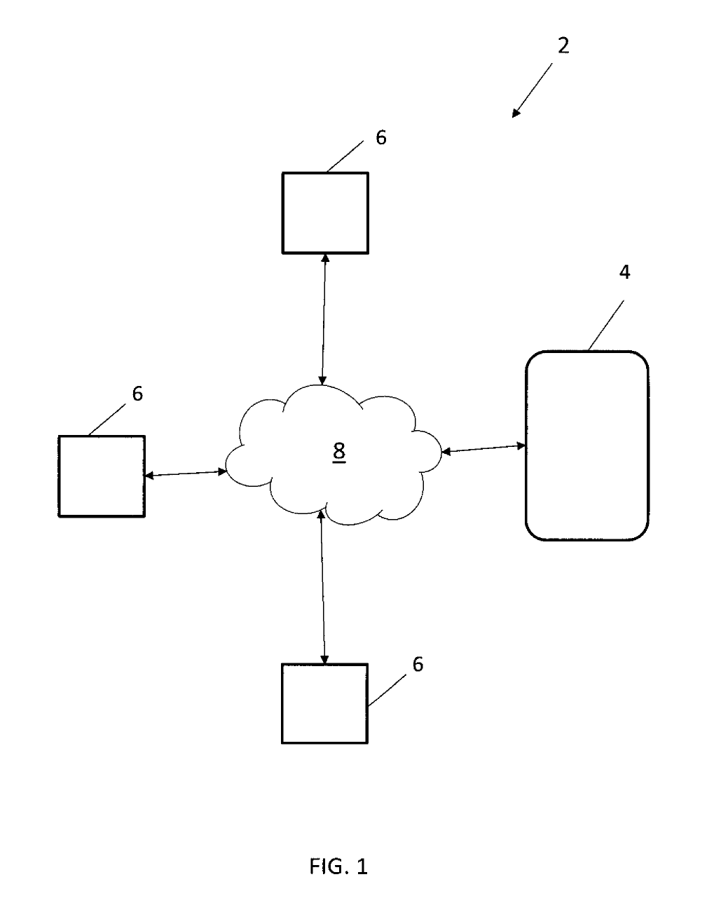

Referring to FIG. 1, there is shown a customer preference system 2. The customer preference system 2 includes merchant terminals 6, a preference storage server 4, and a network 8 connecting the merchant terminals 6 to the preference storage server 4.

As used herein, a merchant is an operator of a merchant terminal 6, and in general corresponds to an entity which provides goods and/or services to a customer. A merchant can be, for example, an individual, a group, and/or an organisation. Example merchants are cafés and vending machines.

Also as used herein, a customer is an entity which receives goods and/or services from a merchant, usually in exchange for currency or credit. A customer can be an individual, group, or organisation.

A customer ID token corresponds to data capable of identifying a customer. A customer ID token can correspond to and/or include, for example, a unique alphanumeric code.

It will be appreciated that FIG. 1 depicts the implementation schematically. The merchant terminals 6, in particular, may be wired or wireless devices, and their connections to the network 8 may utilise various technologies and bandwidths. For example, a merchant terminal 6 can be selected from (without limitation): computers or microcontrollers with wired (eg LAN, cable, ADSL, dial-up) or wireless (eg WLAN, cellular) connections; wireless portable/handheld devices such as PDA's or mobile/cellular telephones and tablets; card readers and other electronic point of sale devices; and wireless devices in communication with a wired device. The protocols and interfaces for communication between the merchant terminals 6 and the preference storage server 4, may also vary according to available technologies, and includes (again without limitation): wired TCP/IP (Internet and intranet) protocols; GPRS, WAP and/or 3G and/or 4G protocols (for handheld/cellular/tablet devices); and/or proprietary communications protocols. The preference storage server 4 can be part of a cloud storage server.

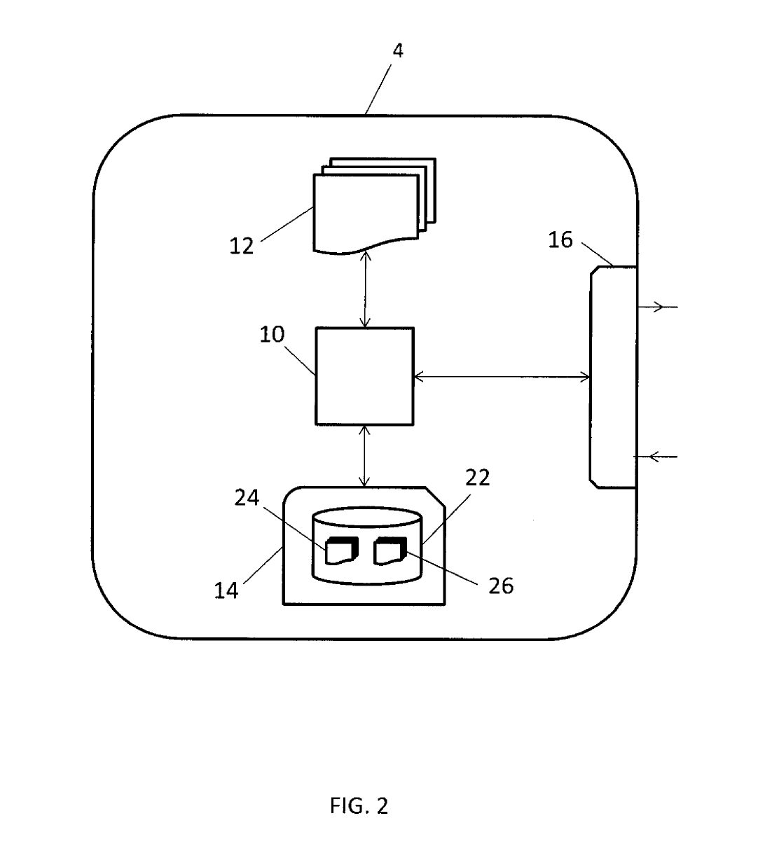

Referring to FIG. 2, a schematic diagram of the preference storage server 4 shows a processor 10 for processing instructions, a memory 12, a non-volatile storage 14 including instructions for processing by the processor 10 and data, and a network interface 16. The data 20 includes a customer database 22.

The customer database 22 is configured for storing customer preference records 24 and optionally customer identification records 26. Customer preference records 24 can be added to or removed from the database 22, and furthermore the customer preference records 24 can be modified within the database 22. Similarly, customer identification records 26 can be added to or removed from the database 22, and can be modified within the database 22. Each customer identification record 26 is associated with one customer. In some embodiments, each customer will be uniquely associated with a single customer identification record 26; however this is not a requirement. Each customer identification record 26 is associated with one or more customer preference records 24, optionally such that each customer preference record 24 is associated with one customer identification record 26. Customer preference records 24 contain information relating to a predetermined preference of a customer. A preference corresponds to a preferred choice of goods and/or services offered by the merchant. For example, a preferred type of coffee offered at a café.

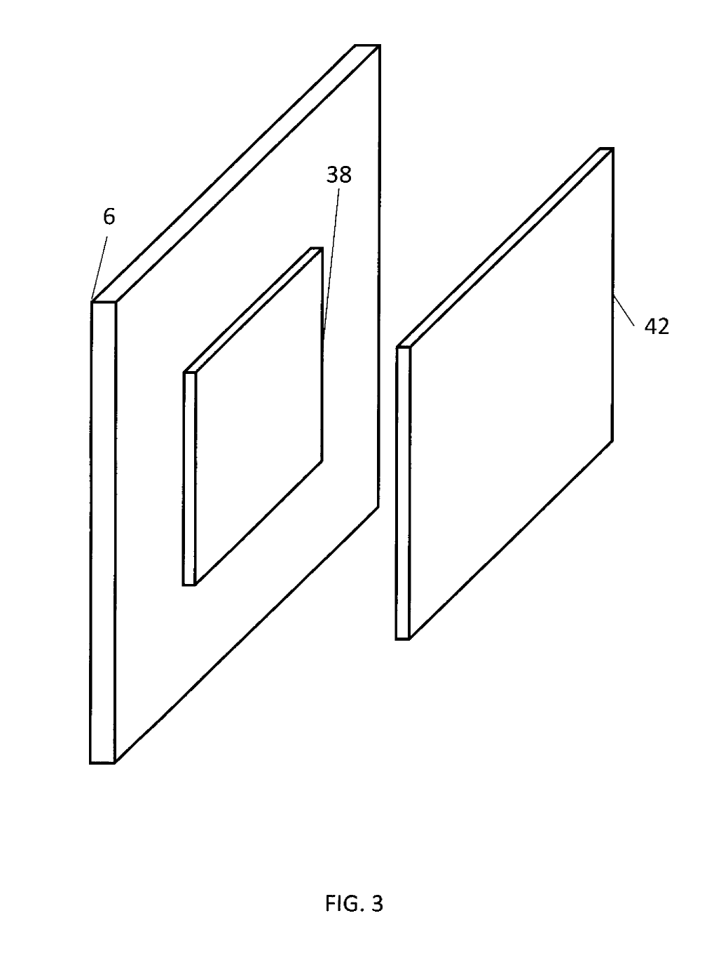

Referring to FIG. 3, the merchant terminals 6 include customer identification means 38 for identifying a customer by obtaining a customer ID token from the customer, the customer identification means 38 being associated with a separate customer identification device 42 configured for identifying the customer to the customer identification means 38. Several embodiments of the customer identification means 38 and customer identification devices 42 are described below.

In an embodiment, the customer identification device 42 is a barcode, for example a one or two dimensional barcode, located on a card or other surface, and the customer identification means 38 includes a barcode scanner configured for identifying data, including the customer ID token, stored within the barcode and transferring the data to the corresponding merchant terminal 6. In another embodiment, the customer identification device 42 is a unique visual recognition image, and the customer identification means 38 includes an image reader, for example a camera, and further hardware and software configured for identifying features within the unique visual recognition image which act to identify the customer. The unique visual recognition image may include, but not be limited to; a picture, a diagram, a logo or a signature.

In an embodiment, the customer identification device 42 corresponds to a biometric indicator. A biometric indicator can be, for example, a finger or thumb print which can be identified by a fingerprint scanner (corresponding to the customer identification means 38). Another example of a biometric indicator is a capture device, such as a camera, employing facial recognition technology, corresponding to the customer identification means 38.

In another embodiment, as is assumed for the remainder of the discussion, the customer identification device 42 is a personal electronic transmitting device. The personal electronic transmitting device can be any suitable device for electronically providing data including the customer ID token to the merchant terminal 6. Example personal electronic transmitting devices include Near-Field Communication (NFC) devices. An NFC device is configured for providing information, such as the customer ID token, via a wireless connection when in close proximity to another NFC device. For the purposes of this discussion, a NFC transmitter is an NFC device including a customer ID token, and an NFC reader is an NFC device configured for receiving the customer ID token from the NFC transmitter. It is understood that an NFC transmitter may provide further information in conjunction with the customer ID token, and it is further understood that the NFC reader may provide information to the NFC transmitter simultaneously or separately to the NFC transmitter providing the customer ID token to the NFC reader.

Possible NFC transmitters include active NFC transmitters, such as mobile phones (in particular so-called smartphones), and passive NFC transmitters, such as NFC tags. NFC tags correspond to passive RFID devices, which are configured for providing data to an NFC reader when activated by the NFC reader. In the present case, the data includes at least the customer ID token. In contrast, mobile phones may allow for the associated data to be easily rewritten, for example when a single mobile phone includes a plurality of different profiles corresponding to different customers. In this case, each profile is associated with different associated data.

NFC tags can be incorporated into various different products, for example: labels, in particular adhesive labels, that can be attached to other products, for example a wallet or mobile phone; cards, such as well known ‘smartcards’; embedded within a silicon band that is incorporated onto another product, for example a refillable beverage (hot or cold) container; embedded within a product otherwise used for an unrelated purpose, such as a cup, tray, plate, etc.

NFC readers typically include antenna, a power source, and processing means. For use with NFC tags, the antenna is configured for providing wireless power to the NFC tag, through radiofrequency coupling. The antenna is further configured to receive data, including the customer ID token, from the NFC tag through the radiofrequency coupling. The processing means, typically a microprocessor or microcontroller, is configured to transcode the received data into a usable form. For use with active NFC transmitters, the NFC reader is not required to power the NFC transmitter, and therefore the radiofrequency coupling is not required to provide power to the NFC transmitter.

The merchant terminal 6 is configured to provide the customer ID token to the preference storage server 4. The merchant terminal 6 can be in electronic communication with the preference storage server 4, optionally through a network, for example the Internet. The merchant terminal 6 can be configured for providing the customer ID token in a secure manner, for example through an SSL based connection.

In an embodiment, the preference storage server 4 is configured for identifying a customer identification record 26 associated with the customer ID token. For example, the customer identification record 26 may simply correspond to the same information as contained within the customer ID token, or may comprise further information, such as name, age, occupation, etc of the customer.

In another embodiment, the preference storage server 4 is configured for identifying customer preference records 24 directly from the customer ID token, for example by identifying customer preference records 24 corresponding to the particular customer ID token.

A set 28 of customer preference records 24 is then determined by the preference storage server 4. The set 28 includes customer preference records 24 associated with the customer identification record 26 or customer ID token, as appropriate. A refined set 30 can then be determined. In some implementations, the refined set 30 simply corresponds to the set 28, however in other implementations the refined set 30 is determined based on the set 28 and optionally one or more further parameters.

A particular customer preference system 2 may be configured such that there are one or more further parameters which are required each time the refined set 30 is created and/or that there are one or more further parameters which may be optionally required, for example as specified by the particular merchant associated with the merchant terminal 6. It is understood that the customer preference system 2 may incorporate none, some, or all of the further parameters discussed below.

A first further parameter is the merchant ID associated with the particular merchant terminal 6 communicating with the preference storage server 4. The merchant ID is of particular use when the preference storage server 4 includes customer preference records 24 associated with a variety of different merchants. In this case, it can be desirable that only customer preference records 24 relevant to the particular merchant terminal 6 be provided.

A second further parameter is the time of day in which the communication with the preference storage server 4 occurs. For example, a customer preference may be dependent on the time of day, or the day of the week, that the customer is making a purchase.

A third further parameter is the merchant type associated with the particular merchant terminal 6 communicating with the preference storage server 4. The merchant type identifies the types of goods and/or services provided by the particular merchant. The merchant type may be composed of a plurality of merchant subtypes. For example, a merchant which operates as a café may have a merchant type including “coffee merchant” subtype and “cake merchant” subtype. One merchant can operate more than one merchant terminal 6, or one merchant terminal with more than one customer identification means 38, each associated with a different merchant type. This may be advantageous where a customer can indicate, for example, that they would like to purchase a “coffee” by selecting the merchant terminal 6 or customer identification means 38 associated with “coffee”, and through the method described select their preferred coffee.

It is envisaged that other further parameters may be incorporated depending on the requirements of the merchants and/or customers utilising the described system.

The refined set 30 is presented to the merchant operating the merchant terminal 6, optionally through communication of the refined set 30 to the merchant terminal 6, such that the merchant is then able to provide the customer with the customer's preferred goods and/or services.

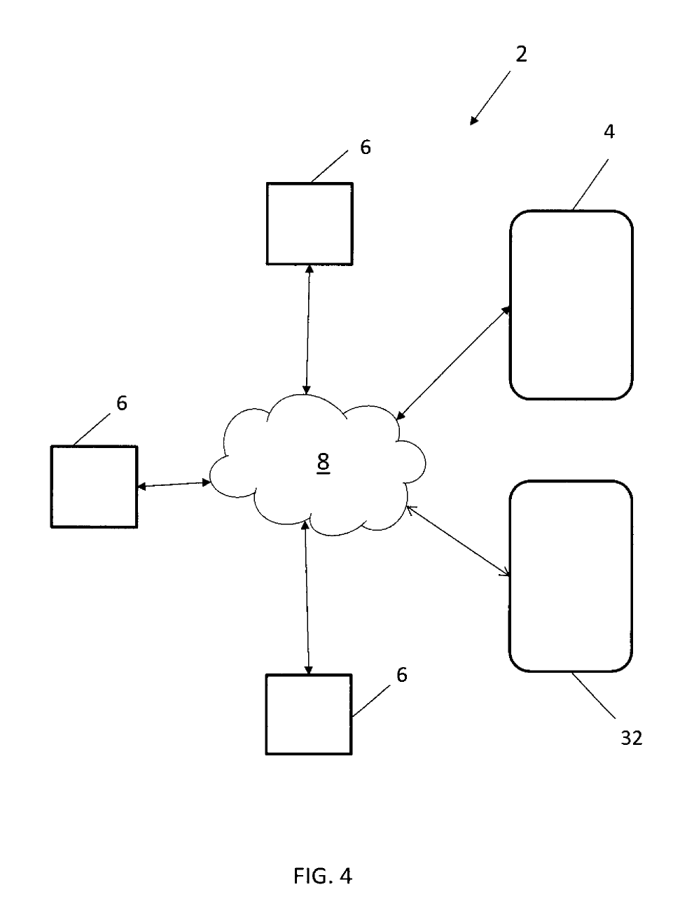

Referring to FIG. 4, according to an embodiment, the customer preference system 2 further includes a purchase payment server 32. The purchase payment sever 32 is in communication with the merchant terminals 6. The purchase payment server 32 can simply correspond to further instructions and data located in the non-volatile storage 14 of the preference storage server 4 of FIG. 2, or alternatively may be a separate server in communication with the merchant terminals 6 and optionally the preference storage server 4.

The purchase payment server 32 includes a purchase database including customer purchase records. A customer purchase record can be associated with a purchase ID token, which can be the same or different data as the customer ID token. In this way, a customer can have an associated customer purchase record. In an embodiment, each customer purchase record is uniquely associated with a customer. It can be a requirement that each customer is associated with a customer purchase record. A customer purchase record provides information allowing for the payment of the preferred goods and/or services.

The customer purchase record can be a credit record, which corresponds to credit a customer has previously provided, usually in the form of a credit payment, to the purchase payment server 32. It is envisaged that credit may be provided in other ways, for example through a promotion or a lottery.

The customer purchase record can also, or instead, be a payment record, which corresponds to previously provided payment instructions. For example, a payment record can correspond to credit card details, such that an associated credit account can be used to make payments on behalf of the customer.

The merchant terminal 6 can be configured to communicate with the purchase payment server 32 either simultaneously with the preference storage server 4, or as a subsequent step after communication with the preference storage server 4.

In either case, where a customer purchase record is present, associated with the purchase ID token (which may be the customer ID token), the purchase payment server 32 is then configured to determine whether a payment can be made based on the customer purchase record. For example, the purchase payment server 32 can be configured to determine whether the customer has enough credit to make the payment. In this way, embodiments including a purchase payment server 32 can allow for selection and payment of the goods and/services of a merchant by a customer with little to no direct interaction with the merchant.

There are several different methods for a customer to update the customer preference records 24 associated with their customer ID token. The following are several, non limiting, example methods.

In a first example, the customer can update their customer preference records 24 when making a preference selection at a merchant. The customer may do so by informing the merchant that instead of using their customer identification device to make a preference selection, they want to update their customer preference records 24. The update can be automatic, and based on a good(s) and/or service(s) being purchased simultaneously by the customer, or manual, where the merchant updates the customer preference records 24 appropriately, for example through a computer interface.

In a second example, the customer can update their customer preference records 24 from a customer network device. A customer network device is configured for communicating with the preference storage server 6 through the network 8, but is itself not a merchant terminal 6. Example customer network devices include computers and smartphones. The customer may be required to log on to a website in order to update their customer preference records 24, or may obtain access through their associated customer identification device. In an example of the later case, the customer identification device is a NFC tag, and the customer uses their smartphone as a NFC reader to read the customer ID token from the NFC tag in order to obtain access to their customer preference records 24. The customer may also use an application (for example, a so-called ‘app’), present on their smartphone to directly update their preferences from their smartphone.

For embodiments incorporating a purchase payment server 32, customer purchase records can be updated using analogous methods and equipment to that described for update customer preference records 24.

An example of an implementation of the customer preference system 2 within a retail and customer service environment is now described. In particular, non-limiting reference will be made to a café serving food and drink, and in particular coffee.

It is not uncommon for customers of a café to order the same particular coffee. The preference for the type of coffee may also, for example, be dependent on the time of day, and/or the day of the week. The customer presents a customer identification device 42 to customer identification means 38. For example, the customer identification device 42 may correspond to a NFC tag incorporated into a reusable coffee cup, and the customer identification means 38 may corresponds to a NFC reader onto which the coffee cup is placed. In another example, the customer presents a smart phone configured as a NFC transmitter to a NFC reader.

A barista can then proceed to prepare the coffee for the customer based on the refined set 30 presented to the barista via the merchant terminal 6. There can be several different parameters for determining the type of coffee to prepare for the customer. For example, a customer prefers espresso coffee with no sugar in the morning on weekdays but lattes with one sugar in the afternoon and on weekends.

Optionally, the café also provides for payment for the coffee through an associated purchase payment server 32. The price of the coffee is determined after the customer preference system 2 determines the type of coffee to prepare for the customer. The payment can be effected automatically, or the customer can be prompted to authorise the payment to occur.

Another example of an implementation of the customer preference system 2 is described in respect of vending machines. A customer may regularly purchase a particular item, for example, a particular soft drink from vending machines (the same or different machines). In order to reduce the time taken in ordering the particular item, the customer can utilise an NFC device to select the desired item and, optionally, to pay for it. Similar to the café example described, the customer may prefer different items at different times or in different situations. This example is particularly advantageous in cases where a vending machine allows beverages to be configured from a selection of flavours, carbonation levels, sweetness variations and/or chill levels. The vending machine can provide a customer with their preferred configuration without requiring direct input from the customer, based on the refined set 30 presented to the vending machine (i.e. the merchant terminal 6).

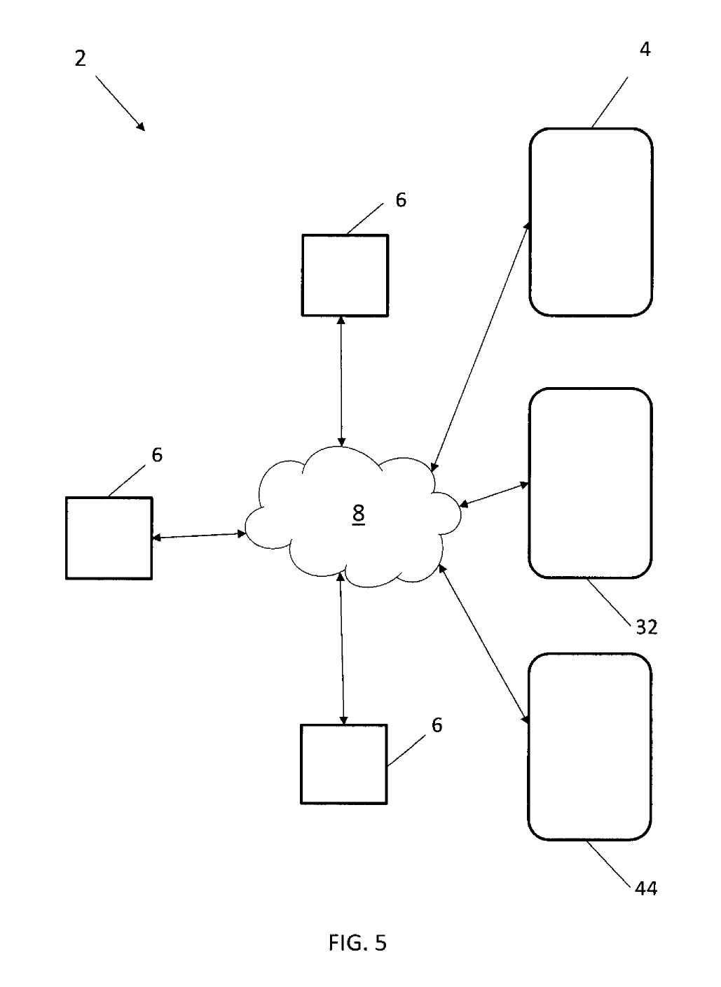

According to an embodiment as shown in FIG. 5, the customer preference system 2 further includes a loyalty program. Such a program can be implemented by including a purchase history storage server 44. It is understood that further embodiments may include the purchase history storage server 44 and the preference storage server 4, while not incorporating the purchase storage server 32.

The purchase history storage server 44 is configured for storing previous purchase data associated with a particular customer ID token. For example, the previous purchase data may include previous quantities paid by a customer, previous goods and/or services purchased by a customer, or other relevant data.

The purchase history storage server 44 is configured for receiving customer ID tokens, for example from a merchant terminal 6 or, alternatively, from the preference storage server 4, or by other means. The purchase history storage server 44 is further configured for receiving purchase data from the merchant terminal 6, associated with a purchase made by a customer associated with the customer ID token. For example, the purchase data may include a type of coffee purchase and the associated amount paid for the coffee.

The purchase data stored within the purchase history storage server 44 can be utilised for providing incentives to customers of a merchant. In an embodiment, when the purchase history storage server 44 is configured for providing the stored purchase data associated with a particular customer ID token to a merchant terminal 6 simultaneously with, or in conjunction with, the refined set 30 that is provided to the merchant terminal 6 by the preference storage server 4. The merchant terminal 6 (or the merchant associated with the merchant terminal 6) can then utilise this information when dealing with the customer, for example by providing a discounted or free good or service when the customer has made a certain number of previous purchases (e.g. a loyalty program).

Alternatively, the purchase history storage server 44 can be configured for determining a discount or other benefit to the customer automatically, based on previously provided rules. For example, a customer may receive a free coffee after having purchased ten previous coffees from the same merchant. When the customer preference system 2 includes both a purchase storage server 32 and a purchase history storage server 44, the purchase storage server 32 and the purchase history storage server 44 can be in communication and the discount or other benefit can automatically be taken into account when the purchase is made (processed) by the purchase storage server 32. For example, the purchase history storage server 44 may instruct the purchase storage server 32 to apply a discount to the total price of a purchase based on previous purchases made, and the purchase storage server 32 can then automatically deduct the discount when processing the payment.

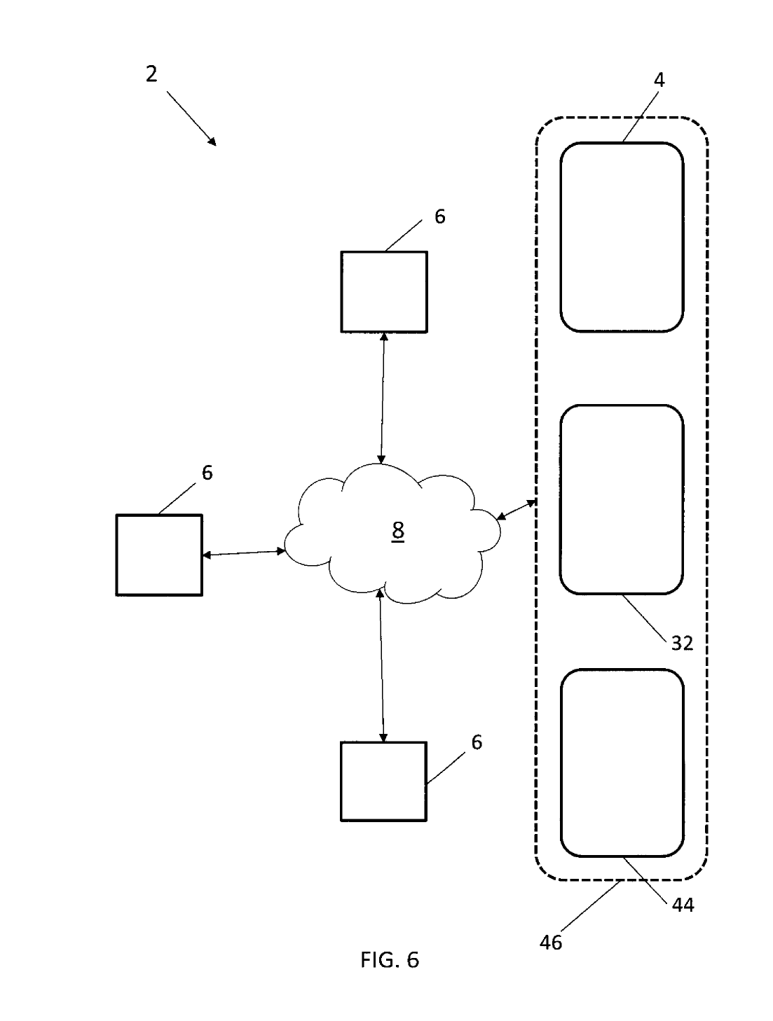

Referring to FIG. 6, it is noted that two or more of the preference storage server 4, purchase storage server 32, and the purchase history storage server 44 can correspond to the same server 46 (which may be a cloud server corresponding to a plurality of interlinked servers).

Further modifications and improvements may be made without departing from the scope of the present invention. Furthermore, different embodiments described can be utilised in conjunction. For example, a customer preference system 2 may include different customer identification means 38 and corresponding different customer identification devices 42.

The claims defining the invention are as follows:

1. A method for determining a customer preference, the method including the steps of:
receiving, at a merchant terminal, a customer ID token from a customer identification device;
the merchant terminal communicating the customer ID token to a preference storage server, the preference storage server including a plurality of customer preference records, each associated with one of a plurality of different customer ID tokens;
the preference storage server determining a refined set of customer preference records associated with the customer ID token; and
the preference storage server communicating to a merchant associated with the merchant terminal the refined set of customer preference records.

2. A method as claimed in claim 1, including the step of: the preference storage server determining the refined set of customer preference records based on a set of customer preference records and one or more further parameters.

3. A method as claimed in claim 2, wherein the one or more further parameters comprise a parameter corresponding with the merchant associated with the merchant terminal.

4. A method as claimed in claim 2, wherein the one or more further parameters comprise a parameter corresponding with the time of day at which the customer ID token is received at the merchant terminal.

5. A method as claimed in claim 2, wherein the one or more further parameters comprise a parameter corresponding with a merchant type associated with the merchant terminal.

6. A method as claimed in claim 1, wherein the customer identification device is a Near Field Communication (NFC) device, and wherein the merchant terminal includes a NFC reader, and wherein the method further includes the step of the NFC reader reading information stored on or with the NFC device, the information including the customer ID token.

7. A method as claimed in claim 1, wherein the merchant terminal is configured to communicate with the preference storage server over a network.

8. A method as claimed in claim 1, wherein the refined set of preference records corresponds to a purchase to be made by the customer from the merchant, and the method including the steps of:
the merchant terminal receiving a purchase ID token from the customer identification device, and communicating the purchase ID token to a purchase payment server;
the purchase payment server determining a customer purchase record associated with the purchase ID token;
the purchase payment server determining that the purchase can be paid for based on the customer purchase record; and
the purchase payment server communicating to the merchant terminal that the purchase has been paid for.

9. A method as claimed in claim 8, including the step of the merchant terminal communicating the refined set of customer preference records to the purchase payment server.

10. A method as claimed in claim 8, including the step of the preference storage server communicating the refined set of customer preference records to the purchase payment server.

11. A method as claimed in claim 8, including the step of a purchase history storage server, including purchase data associated with the customer ID token, providing purchase data to the merchant terminal.

12. A method as claimed in claim 8, including the step of a purchase history storage server, including purchase data associated with the customer ID token, providing the purchase data to the purchase storage server.

13. A method as claimed in claim 8, including the step of the purchase storage server providing a discount to a purchase made by the customer based on purchase data provided by a purchase history storage server.

14. A method as claimed in claim 13, including the step of storing within the purchase history storage server purchase data associated with the purchase.

15. A system for determining customer preferences, including:
a preference storage server including a database; and
one or more merchant terminals in communication with the preference storage server,
wherein the database includes a plurality of customer preference records, each associated with one of a plurality of different customer ID tokens, and wherein the preference storage server is configured for:
receiving a customer ID token from a merchant terminal,
determining a refined set of customer preference records associated with the customer ID token; and
communicating to a merchant associated with the merchant terminal the refined set of customer preference records.

16. A system for determining customer preferences as claimed in claim 15, wherein the preference storage server is further configured for determining a set of customer preference records based on the customer ID token and one or more further parameters, and wherein the refined set of customer preference records is based on the set of customer preference records and the one or more further parameters, and wherein the refined set of preference records corresponds to a purchase, and wherein the merchant terminal is configured for receiving a purchase ID token from the customer identification device, and the including a purchase payment server, the purchase payment server configured for:
receiving the purchase ID token from the merchant terminal;
determining a customer purchase record associated with the purchase ID token;
determining that the purchase can be paid for based on the customer purchase record; and
communicating to the merchant terminal that the purchase has been paid for.
